(19) United States
(12) Patent Application Publication
(10) Pub. No.: US 2018/0254685 A1
(43) Pub. Date: Sep. 6, 2018

(54) MOTOR AND ELECTRIC OIL PUMP

(71) Applicant: Nidec Tosok Corporation, Zama-shi (JP)

(72) Inventor: Yusaku SEKI, Zama-shi (JP)

(21) Appl. No.: 15/907,361

(22) Filed: Feb. 28, 2018

(30) Foreign Application Priority Data
Mar. 3, 2017 (JP) 2017-040750

(51) Int. Cl. H02K 11/22; H02K 11/33; H02K 7/14; F04C 2/10; F04C 2/08; F04C 13/00; F04C 15/00

(52) U.S. Cl. CPC H02K 11/022; H02K 11/33; H02K 7/14; F04C 2/10; F04C 2240/403; F04C 13/001; F04C 15/008; H02K 2211/03; F04C 2/084

(57) ABSTRACT

A motor includes a shaft. The motor includes a motor section and a motor-driving section that is positioned on one side of the motor section in the axial direction and that drives the motor section. The motor section includes a rotor that is rotatable around the shaft, a stator that is disposed outside of the rotor in a radial direction, and a housing that contains the rotor and the stator. The motor-driving section includes a circuit board and a plurality of heat-generating elements mounted on the circuit board. The motor includes an inverter circuit that controls driving of the motor section and an inverter case that contains the inverter circuit. The inverter circuit includes a plurality of blocks including a power source block, a drive block, and a control block, and at least one of the plurality of blocks is separated from the other blocks.

### CROSS REFERENCE TO RELATED APPLICATIONS

This application claims the benefit of priority to Japanese Patent Application No. 2017-040750 filed on Mar. 3, 2017. The entire contents of this application are hereby incorporated herein by reference.

### BACKGROUND OF THE INVENTION

### 1. Field of the Invention

The present invention relates to a motor and an electric oil pump.

### 2. Description of the Related Art

In recent years, continuously variable transmissions (CVT), dual clutch transmissions (DCT), and the like have been used as the transmission of an automobile or the like. In order to improve fuel efficiently, various configurations of the transmissions have been examined.

It is desired that a transmission have a function of supplying oil by using a motor when, for example, the transmission is in an idling-reduction mode. To realize this function, an electric oil pump including an inverter circuit, a motor, and a pump is required.

For example, Japanese Unexamined Patent Application Publication No. 2015-175291 discloses an electric oil pump including an inverter circuit in which various elements are mounted on a circuit board.

An inverter circuit includes various elements, such as an element that generates noise, such as a pulse width modulation (PWM) signal, and an element that generates a large amount of heat in operation.

However, in the electric oil pump disclosed in Japanese Unexamined Patent Application Publication No. 2015-175291, these elements are mounted on the circuit board of the inverter circuit, and therefore malfunctioning due to noise, deterioration of signal quality due to interference between the elements, or an influence of heat generated by the elements may occur.

### SUMMARY OF THE INVENTION

According to an exemplary embodiment of the present application, a motor includes a motor section that includes a shaft that is rotatably supported around a central axis extending in an axial direction, and a motor-driving section that is positioned on one side of the motor section in the axial direction and that drives the motor section. The motor section includes a rotor that is rotatable around the shaft, a stator that is disposed outside of the rotor in a radial direction, and a housing that contains the rotor and the stator. The motor-driving section includes an inverter circuit that includes a circuit board and a plurality of heat-generating elements mounted on the circuit board and that controls driving of the motor section, and an inverter case that contains the inverter circuit. The inverter circuit includes a plurality of blocks including a power source block, a drive block, and a control block, and at least one of the plurality of blocks is separated from the other blocks.

With the exemplary embodiment of the present application, it is possible to provide a motor and an electric oil pump that can reduce malfunctioning due to noise, deterioration of signal quality due to interference between elements, or the influence of heat generated by the elements.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view of an electric oil pump.

FIG. 2 is an enlarged sectional view of a motor-driving section.

FIG. 3 is an enlarged sectional view of a motor-driving section.

FIG. 4 is a plan view of a motor-driving section.

FIG. 5 is an enlarged sectional view of a motor-driving section.

FIG. 6 is an enlarged sectional view of a motor-driving section according to a modification.

FIG. 7 is an enlarged sectional view of a motor-driving section.

FIG. 8 is an enlarged sectional view of a motor-driving section according to a modification.

FIG. 9 is an enlarged sectional view of a motor-driving section.

FIG. 10 is an enlarged sectional view of a motor-driving section.

FIG. 11 is a sectional view of an electric oil pump.

### DETAILED DESCRIPTION OF THE PREFERRED EMBODIMENTS

Hereinafter, embodiments of the present invention will be described with reference to the drawings. In the drawings, for the sake of simplicity, the scales and the number of elements may be changed from those of an actual structure.

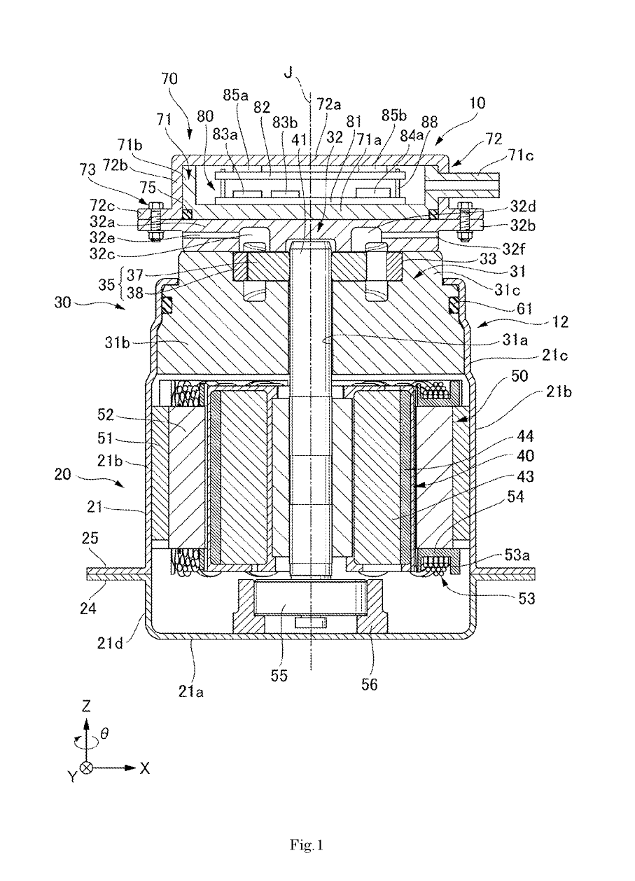

In some of the drawings, an XYZ-coordinate system is shown as a three-dimensional orthogonal coordinate system. In the XYZ-coordinates system, the Z-axis direction is a direction parallel to the direction in which a central axis J extends in FIG. 1. The X-axis direction is a direction parallel to the direction in which a top panel 72a of an inverter cover 72 extends in FIG. 1, that is, the left-right direction in FIG. 1. The Y-axis direction is a direction that is perpendicular to both of the X-axis direction and the Z-axis direction.

In the following description, the positive side in the Z-axis direction (+Z-side) will be referred to as the “front side”, and the negative side in the Z-axis direction (−Z-side) will be referred to as the “rear side”. The “rear side” and the “front side” are used only for description and do not limit actual positional relationships or actual directions. Unless otherwise noted, the direction parallel to the central axis J (the Z-axis direction) will be simply referred to as the “axial direction”, the radial directions from the central axis J will be simply referred to as the “radial direction”, and the circumferential direction around the central axis J, that is, the periaxial direction (θ-direction) around the central axis J will be simply referred to as the “circumferential direction”.

In the present specification, the phrase “thermally contact” represents not only a case where some members directly contact each other but also a case where another member, which contributes to heat transfer, is interposed between these members. In the present specification, the phrase “extending in an axial direction” represents not only a case of extending strictly in the axial direction (the Z-axis direction) but also a case of extending in a direction that is inclined at an angle of 45° or less relative to the axial direction. In the present specification, the phrase “extending in a radial direction” represents not only a case of extending strictly in the radial direction, that is, a direction perpendicular to the axial direction (the Z-axis direction) but also a case of extending in a direction that is inclined at an angle of 45° or less relative to the radial direction.

FIG. 1 is a sectional view of an electric oil pump 10 according to an embodiment.

The electric oil pump 10 according to the present embodiment includes a motor section 20, a pump section 30, and a motor-driving section 70. The motor section 20, the pump section 30, and the motor-driving section 70 are arranged in the axial direction.

The motor section 20 includes a shaft 41 that is rotatably supported around the central axis J extending in the axial direction and drives the pump by rotating the shaft 41. The pump section 30 is positioned on the front side (+Z-side) of the motor section 20, is driven by the motor section 20 via the shaft 41, and discharges oil. The motor-driving section 70 is positioned on the front side (+Z-side) of the pump section 30 and controls driving of the motor section 20.

Hereinafter, each element will be described in detail.

As illustrated in FIG. 1, the motor section 20 includes a housing 21, a rotor 40, the shaft 41, a stator 50, and a bearing 55.

The motor section 20 is, for example, an inner-rotor motor. The rotor 40 is fixed to the outer peripheral surface of the shaft 41, and the stator 50 is disposed outside the rotor 40 in the radial direction. The bearing 55 is disposed at an end portion of the shaft 41 on the rear side in the axial direction (−Z-side) and rotatably supports the shaft 41.

As illustrated in FIG. 1, the housing 21 is shaped like a thin-walled cylinder having a bottom. The housing 21 includes a bottom-surface portion 21a, a stator-holding portion 21b, a pump-body-holding portion 21c, a side-wall portion 21d, and flange portions 24 and 25. The bottom-surface portion 21a forms the bottom of the housing 21. The stator-holding portion 21b, the pump-body-holding portion 21c, and the side-wall portion 21d form a cylindrical side wall centered on the central axis J. In the present embodiment, the inside diameter of the stator-holding portion 21b is larger than the inside diameter of the pump-body-holding portion 21c. The outer surface of the stator 50, that is, the outer surface of a core back 51 (described below) is fitted to the inner surface of the stator-holding portion 21b. Thus, the stator 50 is contained in the housing 21. The flange portion 24 extends outward in the radial direction from an end of the side-wall portion 21d on the front side (+Z-side). The flange portion 25 extends outward in the radial direction from an end of the stator-holding portion 21b on the rear side (−Z-side). The flange portion 24 and the flange portion 25 face each other and are fastened to each other by using a fastener (not shown). Thus, the motor section 20 and the pump section 30 are fixed to the inside of the housing 21 in a sealed state.

As the material of the housing 21, for example, a zinc-aluminum-magnesium alloy or the like can be used. To be specific, a hot-dip zinc-aluminum-magnesium alloy steel sheet or strip can be used. A bearing holder 56 for holding the bearing 55 is disposed on the bottom-surface portion 21a.

The rotor 40 includes a rotor core 43 and a rotor magnet 44. The rotor core 43 surrounds the shaft 41 periaxially (in the θ-direction) and is fixed to the shaft 41. The rotor magnet 44 is fixed to the outer surface of the rotor core 43 in the periaxial direction (in the θ-direction). The rotor core 43 and the rotor magnet 44 rotate together with the shaft 41.

The stator 50 surrounds the rotor 40 periaxially (in the θ-direction) and rotates the rotor 40 around the central axis J. The stator 50 includes the core back 51, teeth 52, coils 53, and bobbins (insulators) 54.

The shape of the core back 51 is a cylindrical shape that is coaxial with the shaft 41. The teeth 52 extend from the inner surface of the core back 51 toward the shaft 41. The teeth are arranged at regular intervals in the circumferential direction of the inner surface of the core back 51. The coils 53 are conductive wires 53a that are wound around the bobbins (insulators) 54. The bobbins (insulator) 54 are attached to the teeth 52.

The bearing 55 is disposed on the rear side (−Z-side) of the rotor 40 and the stator 50 and is held by the bearing holder 56. The bearing 55 supports the shaft 41. The shape, the structure, and the like of the bearing 55 are not particularly limited. Any existing bearing can be used as the bearing 55, as appropriate.

The pump section 30 is disposed on one side of the motor section 20 in the axial direction, specifically, on the front side (+z-side). The pump section 30 has the same rotation axis as the motor section 20 and is driven by the motor section 20 via the shaft 41. The pump section 30 is a positive displacement pump, which pressurizes and feeds oil by increasing and decreasing the volume of a closed space (oil chamber) in the pump. As the positive displacement pump, for example, a trochoid pump is used. The pump section 30 includes a pump body 31, a pump cover 32, and a pump rotor 35. Hereinafter, the pump body 31 and the pump cover 32 may be also referred to as a “pump case”.

The pump body 31 is positioned on the front side (+Z-side) of the motor section 20. The pump body 31 includes a pump main body 31b, a through-hole 31a that extends through the pump main body 31b in the axial direction of the central axis J, and a protrusion 31c that protrudes from the pump main body 31b toward the front side (+Z-side) in a cylindrical shape. The inside diameter of the protrusion 31c is larger than the inside diameter of the through-hole 31a. The protrusion 31c and the pump main body 31b form a recess 33 that opens toward the pump cover 32. The through-hole 31a opens toward the motor section 20 on the rear side (−Z-side) and opens in the recess 33 on the front side (+Z-side). The shaft 41 is inserted into the through-hole 31a, and the through-hole 31a functions as a bearing that rotatably supports the shaft 41. The recess 33, in which the pump rotor 35 is contained, functions as a pump chamber (hereinafter, also referred to as a “pump chamber 33”).

The pump body 31 is fixed to the inside of the pump-body-holding portion 21c on the front side (+Z-side) of the motor section 20. An O-ring 61 is disposed between the outer peripheral surface of the pump main body 31b and the inner peripheral surface of the pump-body-holding portion 21c in the radial direction. Thus, the space between the outer peripheral surface of the pump body 31 and the inner peripheral surface of the housing 21 in the radial direction is sealed.

As the material of the pump body 31, for example, cast iron can be used.

The pump rotor 35 is attached to the end portion the shaft 41 on the front side (+Z-side) and is contained in the pump chamber 33. The pump rotor 35 includes an inner rotor 37 that is attached to the shaft 41, and an outer rotor 38 that surrounds the outside of the inner rotor 37 in the radial direction.

The inner rotor 37 is an annular gear having teeth on the outer surface thereof in the radial direction. The inner rotor 37 is fixed to the shaft 41 by pressing an end portion of the shaft 41 on the front side (+Z-side) into the inner rotor 37. The inner rotor 37 rotates together with the shaft 41 in the periaxial direction (θ-direction).

The outer rotor 38 is an annular gear that surrounds the outside of the inner rotor 37 in the radial direction and that has teeth on the inner surface thereof in the radial direction. The outer rotor 38 is rotatably contained in the pump chamber 33. In the outer rotor 38, an inner containing chamber (not shown) for containing the inner rotor 37 is formed, for example, in a star shape. Then number of the inner teeth of the outer rotor 38 is larger than the number of the outer teeth of the inner rotor 37.

The inner rotor 37 and the outer rotor 38 mesh with each other. When the shaft 41 rotates the inner rotor 37, the outer rotor 38 rotates in accordance with the rotation of the inner rotor 37. When the inner rotor 37 and the outer rotor 38 rotate, the volume of the space formed between the inner rotor 37 and the outer rotor 38 changes in accordance with the rotational position thereof. By using the change in the volume of the space, the pump rotor 35 suctions oil from a suction port 32c (described below) and pressurizes and discharges the oil from a discharge port 32d. In the present embodiment, it is assumed that a region that is in the space formed between the inner rotor 37 and the outer rotor 38 and whose volume thereof increases (that is, into which oil is suctioned) is a negative-pressure region.

The pump cover 32 is attached to the front side (+Z-side) of the pump body 31. The pump cover 32 includes a pump-cover body 32a, a flange portion 32b, the suction port 32c, the discharge port 32d, a suction opening 32e, and a discharge opening 32f.

The pump cover 32, which is typically made of a metal such as an aluminum alloy, has a large thermal capacity and a large surface area, and thus has a high heat-dissipation efficiency. Because oil having a constant temperature (for example, 120° C.) flows in the pump cover 32, increase of the temperature of the pump cover 32 is suppressed.

The pump-cover body 32a has a disk shape that extends in the radial direction. The pump-cover body 32a covers the opening on the front side (+Z-side) of the recess 33. The flange portion 32b extends in the radial direction at the outer edge on the front side (+Z-side) of the pump-cover body 32a. Because the pump cover 32 has the flange portion 32b, the outside diameter of the pump cover 32 is larger than the outside diameter of the protrusion 31c of the pump body 31.

The suction port 32c is a groove having a crescent shape when seen from the pump rotor 35 toward the front side (+Z-side). As the volume of the space between the inner rotor 37 and the outer rotor 38 increases, the suction port 32c communicates with the pump rotor 35 to a degree corresponding to the increase in the volume. Likewise, the discharge port 32d is a groove having a crescent shape when seen from the pump rotor 35 toward the front side (+Z-side). As the volume of the space between the inner rotor and the outer rotor 38 decreases, the discharge port 32d communicates with the pump rotor 35 to a degree corresponding to the decrease in the volume.

The suction opening 32e extends in the pump-cover body 32a from the suction port 32c toward the −X-side (the left side in the figure) and communicates with the outside. The discharge opening 32f extends in the pump-cover body 32a from the discharge port 32d toward the +X-side (the right side in the figure) and communicates with the outside. The suction opening 32e and the discharge opening 32f are respectively connected via the suction port 32c and the discharge port 32d to the pump rotor 35. Thus, oil can be suctioned into the pump rotor 35 and can be discharged from the pump rotor 35. To be specific, due to a negative pressure that is generated in the pump chamber as the pump rotor 35 rotates, oil stored in an oil pan (not shown) is suctioned into the pump chamber from the suction opening 32e via the suction port 32c. The suctioned oil is discharged to the discharge opening 32f from a pressurizing region via the discharge port 32d.

In the present embodiment, the suction port 32c, the discharge port 32d, the suction opening 32e, and the discharge opening 32f are formed in the pump cover 32. Instead, some or all of these may be formed in the pump body 31.

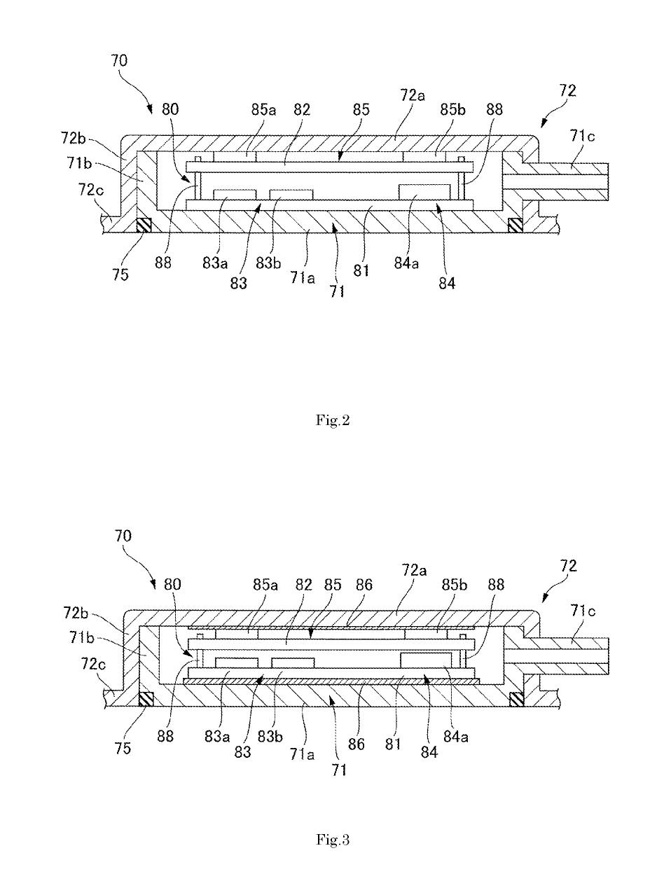

FIG. 2 is an enlarged sectional view of the motor-driving section 70 according to the present embodiment.

The motor-driving section 70 is disposed on the front side (+Z-side) of the pump cover 32 and controls driving of the motor section 20. The motor-driving section 70 includes an inverter housing 71, the inverter cover 72, and an inverter circuit 80.

The inverter housing 71 includes a housing body 71a, a side wall 71b, and a connector portion 71c.

The housing body 71a provides a bottom surface on which the inverter circuit 80 (described below) is disposed.

The side wall 71b protrudes toward the front side (+Z-side) from both ends of the housing body 71a. The side wall 71b and the housing body 71a form a recess having an opening on the front side (+Z-side). The inverter circuit 80 is contained in the recess of the inverter housing 71.

The connector portion 71c protrudes from a part of the side wall 71b toward, for example, the +X-side (the right side in the figure) in the radial direction. The connector portion 71c has a power-source opening that opens toward the +X-side (the right side in the figure) in the radial direction. In the power-source opening, a connector (not shown), for supplying electric power to the inverter circuit 80, is disposed. An external power source (not shown) is connected the connector portion 71c.

The inverter cover 72 is disposed on the front side (+Z-side) of the pump cover 32 so as to cover the housing body 71a and the side wall 71b. That is, the inverter cover 72 covers the recess of the inverter housing 71. The inverter cover 72 includes the top panel 72a, a side wall 72b, and a flange portion 72c.

The top panel 72a is in contact with a top surface of an end portion the side wall 71b on the front side (+Z-side) and extends in the radial direction.

The side wall 72b is in contact with an outer surface of the side wall 71b of the inverter housing 71 in the radial direction.

The flange portion 72c extends in the radial direction from an end of the side wall 72b on the rear side (−Z-side). An end surface of the flange portion 72c on the rear side (−Z-side) is in contact with a surface of the flange portion 32b of the pump cover 32 on the front side (+Z-side) (see FIG. 1). The inverter cover 72 is fixed to the pump cover 32 by fastening the flange portion 72c of the inverter cover 72 to the flange portion 32b of the pump cover 32 by using fasteners 73, such as bolts and nuts.

An O-ring 75 is disposed between the outer surface of the side wall 71b of the inverter housing 71 and the inner surface of the side wall 72b of the inverter cover 72 in the radial direction. Thus, the space between the outer surface of the inverter housing 71 and the inner surface of the inverter cover 72 in the radial direction is sealed.

The inverter circuit 80 includes a circuit board and heat-generating elements mounted on the circuit board. The inverter circuit 80 supplies electric power for driving the coils 53 of the stator 50 of the motor section 20 and controls driving, rotation, stopping, and the like of the motor section 20. Supply of electric power and electrical communication between the motor-driving section 70 and the coils 53 of the stator 50 are performed by electrically connecting the motor-driving section 70 and the coils 53 by using wiring members (not shown), such as insulated cables.

In the present embodiment, the inverter circuit 80 includes a block 83 in which high-heat-generating elements 83a and 83b are mounted on a circuit board 81, a block 84 in which an intermediate-heat-generating element 84a is mounted on the circuit board 81, and a block 85 in which low-heat-generating elements 85a and 85b are mounted on a circuit board 82. The block 83 and the block 84 share the circuit board 81. The circuit board 81 is electrically insulated from the housing body 71a of the inverter housing 71 and is directly disposed on the housing body 71a. In the block 85, the circuit board 82, which is different from the circuit board 81 and which is disposed on the front side (+Z-side) of the circuit board 81, is used. The low-heat-generating elements 85a and 85b, which are mounted on the circuit board 82, are in direct contact with the top panel 72a of the inverter cover 72.

The circuit board 81 and the circuit board 82 are connected to each other through wiring 88. Print wiring (not shown) is formed on the surface of each of the circuit boards 81 and 82. Preferably, for example, a copper inlay board is used as each of the circuit boards 81 and 82, because the copper inlay board can easily transfer heat generated by the heat-generating elements to the outside and can increase the cooling efficiency.

In the block 83, the high-heat-generating elements 83a and 83b, which generate a large amount of heat, are mounted on the circuit board 81. For example, the block 83 may be a 14-volt three-phase H-bridge drive circuit including a field-effect transistor (MOSFET) and may serve as a drive block (hereinafter, also referred to as the “drive block 83”). The 14-volt three-phase H-bridge drive circuit may generate noise, such as pulse width modulation (PWM) signals. Only one high-heat-generating element or three ore more high-heat-generating elements may be mounted on the circuit board 81.

In the block 84, the intermediate-heat-generating element 84a, which generates a smaller amount of heat than the high-heat-generating elements 83a and 83b, is mounted on the circuit board 81. The block 84 may be, for example, a 14-volt power source circuit including an inductor, a capacitor, and the like and may serve as a power source block (hereinafter, also referred to as the “power source block 84”). In the present embodiment, the block 83 and the block 84 share the circuit board 81. However, different circuit boards may be used. Two or more intermediate-heat-generating elements may be mounted on the circuit board 81.

In the block 85, the low-heat-generating elements 85a and 85b, which generate a smaller amount of heat than the intermediate-heat-generating element 84a, are mounted on the circuit board 82. The block 85 may be, for example, a 5-volt control circuit, which is a microcomputer or the like, and may serve as a control block (hereinafter, also referred to as the “control block 85”). The control block is easily influenced by noise and easily malfunctions due to signal interference with other blocks or the like.

In the present embodiment, the circuit board 82, which is different from the circuit board 81 of the drive block 83 (that is, a circuit board on which the high-heat-generating elements 83a and 83b, which may generate noise such as PWM signals, are mounted), is used in the control block 85. Moreover, the control block 85 is disposed at a position separated from the drive block 83 toward the front side (+Z-side). Furthermore, the circuit board 82 is different from the circuit board 81 of the power source block 84, on which the intermediate-heat-generating element 84a is mounted, and is disposed at a position separated from the power source block 84 toward the front side (+Z-side).

Therefore, the control block 85 is not likely to malfunction due to the influence of noise such as PWM signals, and deterioration of signal quality due to signal interference with other blocks is not likely to occur. Moreover, the control block 85 is not likely to be influenced by heat generated by the high-heat-generating elements 83a and 83b and the intermediate-heat-generating element 84a, which generate a larger amount of heat than the low-heat-generating elements 85a and 85b.

The low-heat-generating elements 85a and 85b of the control block 85 are in direct contact with the top panel 72a of the inverter cover 72, and therefore heat generated by the low-heat-generating elements 85a and 85b can be dissipated from the inverter cover 72.

In the drive block 83 and the power source block 84, the circuit board 81, on which the high-heat-generating elements 83a and 83b and the intermediate-heat-generating element 84a are mounted, is electrically insulated from the housing body 71a of the inverter housing 71 and is directly disposed on the housing body 71a. Therefore, heat generated by the high-heat-generating elements 83a and 83b and the intermediate-heat-generating element 84a is dissipated to the inverter housing 71 via the circuit board 81.

Referring to FIG. 1, first, an operation of the electric oil pump 10 when activated will be described.

In the electric oil pump 10 according to the present embodiment, first, electric power is supplied from an external power source to the motor-driving section 70 via the connector portion 71c. Thus, a driving electric current is supplied from the motor-driving section 70 via a wiring member (not shown), such as an insulated cable, to the coils 53 of the stator 50. When the driving electric current is supplied to the coils 53, the coils 53 generate magnetic fields. Due to the magnetic fields, the rotor core 43 and the rotor magnet 44 of the rotor 40 rotate together with the shaft 41. Thus, the electric oil pump 10 obtains a rotational driving force.

The driving electric current supplied to the coils 53 of the stator 50 is controlled by a power IC, circuit components, and the like, which are heat-generating elements of the inverter circuit 80 of the motor-driving section 70. To be specific, the motor-driving section 70 detects the rotational position of the rotor 40 by detecting a change in the magnetic flux of a sensor magnet (not shown) by using a rotation sensor (not shown). The inverter circuit 80 of the motor-driving section 70 outputs a motor-driving signal corresponding to the rotational position of the rotor 40 and controls the driving electric current supplied to the coils 53 of the stator 50. Thus, driving of the electric oil pump 10 according to the present embodiment is controlled.

When electric power is supplied from the motor-driving section 70 to the coils 53, the coils 53 generate a rotational magnetic field and thereby the rotor core 43 and the rotor magnet 44 rotate. The rotation of the rotor 40 is transmitted to the inner rotor 37 of the pump rotor 35 via the shaft 41, and the inner rotor 37 rotates. Thus, a negative pressure is generated in the pump chamber 33, which faces the suction port 32c.

Next, flow of oil will be described. The suction opening 32e of the electric oil pump 10 is connected to an oil pan (not shown), in which oil is stored, through a flow pipe (not shown), and an end of the flow pipe near the oil pan is immersed in oil. Due to a negative pressure that is generated as the inner rotor 37 of the electric oil pump 10 rotates, oil stored in the oil pan flows through the suction opening 32e into the electric oil pump 10 and reaches the suction port 32c. Oil that has been suctioned from the suction port 32c into the pump chamber 33 is pressurized and fed to the discharge port 32d and is discharged from the discharge port 32d to the discharge opening 32f. Discharged oil is supplied to an inner part of a transmission (not shown). The supplied oil generates oil pressure in the inner part, and then the oil is circulated and is stored in the oil pan again.

In the present embodiment, in the block 85 of the inverter circuit 80 illustrated in FIG. 2, the circuit board 82, which is different from the circuit board 81 of the block 83 and the block 84, is used and is disposed at a position separated from the block 83 and the block 84 toward the front side (+Z-side).

In the present embodiment, for example, a 5-volt control circuit, such as a microcomputer, is disposed in the block 85, which is a control block; for example, a 14-volt three-phase H-bridge drive circuit is disposed in the block 83, which is a drive block; and, for example, a 14-volt power source circuit is disposed in the block 84, which is a power source block.

Therefore, the control circuit of the control block 85 is not likely to malfunction due to the influence of noise, such as PWM signals, generated by the three-phase H-bridge drive circuit disposed in the block 83. Moreover, in the control circuit of the control block 85, deterioration of signal quality due to signal interference or the like with other blocks such as the drive block 83 and the power source block 84 is not likely to occur.

For example, a 5-volt control circuit is disposed in the control block 85, while, for example, a 14-volt three-phase H-bridge drive circuit and a 14-volt power source circuit are respectively disposed in the drive block 83 and the power source block 84. That is, the 14-volt systems are mounted on the circuit board 81 and the 5-volt system is mounted on the circuit board 82, so that the systems of the same voltage level are disposed on the same circuit. Therefore, wiring, to an electric power source voltage, and control are facilitated.

Moreover, in the present embodiment, heat-generating elements are divided, in accordance with the amount of heat generated by the elements, into three groups, which are the high-heat-generating element, the intermediate-heat-generating element, and the low-heat-generating element and which are disposed in different blocks. Therefore, the block 85, in which the low-heat-generating elements 85a and 85b is are disposed, is not likely to be influenced by heat generated by the block 83, in which the high-heat-generating elements 83a and 83b are disposed, and the block 84, in which the intermediate-heat-generating element 84a is disposed.

As described above, the inverter circuit 80 is divided into blocks in accordance with function, power source, and amount of generated heat. Therefore, it is possible to reduce malfunctioning due to noise, deterioration of signal quality due to interference with other blocks, complexity of wiring for applying electric power source voltage, and the influence of direct heat transfer from the heat-generating elements.

In the present embodiment, the inverter housing 71 is disposed on the front side (+Z-side) of the pump cover 32, and the circuit board 81 is electrically insulated from the inverter housing 71 and is in direct contact with the inverter housing 71.

Moreover, in the pump section 30, an oil flow path from the suction opening 32e to the discharge opening 32f is formed, and oil having a temperature lower than or equal to a certain temperature (for example, 120° C.) flows in the pump cover 32.

Therefore, heat generated by the high-heat-generating elements 83a and 83b and the intermediate-heat-generating element 84a, which are mounted on the circuit board 81, is efficiently dissipated via the inverter housing 71 and the pump cover 32, and increase in temperature is suppressed.

In the present embodiment, as illustrated in FIG. 1, the high-heat-generating elements 83a and 83b are disposed on the −X-side (the left side in the figure) of the central axis J in the radial direction relative to the intermediate-heat-generating element 84a. That is, a region on the −X-side (the left side in the figure) of the central axis J in the radial direction is located closer the suction opening 32e. Therefore, it is possible to perform cooling by using low-temperature oil (for example, at 120° C.), whose temperature has not been increased due to movement of the oil in the pump cover 32 and heat dissipated from the elements. Accordingly, cooling of the high-heat-generating elements 83a and 83b can be effectively realized.

Moreover, the low-heat-generating elements 85a and 85b, which are mounted on the circuit board 82, are in direct contact with the top panel 72a of the inverter cover 72. Therefore, heat generated by the low-heat-generating elements 85a and 85b can be dissipated from the inverter cover 72.

In this way, in the present embodiment, elements are classified into three types, which are a high-heat-generating element, an intermediate-heat-generating element, and a low-heat-generating element; and these elements are disposed in different blocks in accordance with the amount of heat generated. Therefore, heat is dissipated through different heat-dissipation paths, and it is possible to increase the cooling efficiency of the entirety of the inverter circuit 80.

Next, a motor-driving section according to an embodiment of the present invention will be described. In the motor-driving section 70 according to the embodiment described above, the circuit board 81 of the inverter circuit 80 is eclectically insulated from the housing body 71a of the inverter housing 71 and is in direct contact with the housing body 71a. However, in the present embodiment, the motor-driving section thermally contacts the housing body 71a via a heat-dissipating member.

FIG. 3 is an enlarged sectional view of a motor-driving section 70 according to the present embodiment.

In the motor-driving section 70 according to the present embodiment, a heat-dissipating member 86, which contributes to heat transfer, is disposed between the circuit board 81 and the housing body 71a. Moreover, a heat-dissipating member 86, which contributes to heat transfer, is disposed between the low-heat-generating elements 85a and 85b and the top panel 72a of the inverter cover 72.

As each of the heat-dissipating members 86, for example, a thermosetting resin having a high thermal conductivity, such as silicone rubber; a heat dissipation sheet, a heat dissipation gel; or the like can be used. When using a thermosetting resin, for example, after applying the resin to the housing body 71a, the circuit board 81 is attached to the housing body 71a by pressing the circuit board 81 against the resin, and the resin is cured. Thus, the circuit board 81 can be easily attached to the inverter housing 71.

In the present embodiment, the efficiency in cooling the circuit board 81 can be increased, because the circuit board 81 of the inverter circuit 80 can more closely contact the housing body 71a by using the heat-dissipating member 86.

The heat-dissipating member 86, which contributes to heat transfer, is disposed between the low-heat-generating elements 85a and 85b of the inverter circuit 80 and the top panel 72a, and therefore the low-heat-generating elements 85a and 85b can more closely contact the top panel 72a. Thus, heat generated by the low-heat-generating elements 85a and 85b can be efficiently dissipated from the inverter cover 72 to the outside, and increase in temperature is suppressed.

In the present embodiment, the heat-dissipating member 86 is disposed at each of a position between the circuit board 81 and the housing body 71a and a position between the low-heat-generating elements 85a and 85b and the top panel 72a. However, the heat-dissipating member 86 may be disposed at only one of these positions.

Next, a motor-driving section according to an embodiment of the present invention will be described. In the motor-driving section 70 according to the embodiment described above, the circuit board of the control block 85 differs from the circuit boards of other blocks, and the control block 85 is disposed at a position separated from the drive block 83 toward the front side (+Z-side). Thus, the influence of noise is reduced. However, in the present embodiment, a noise filter is used.

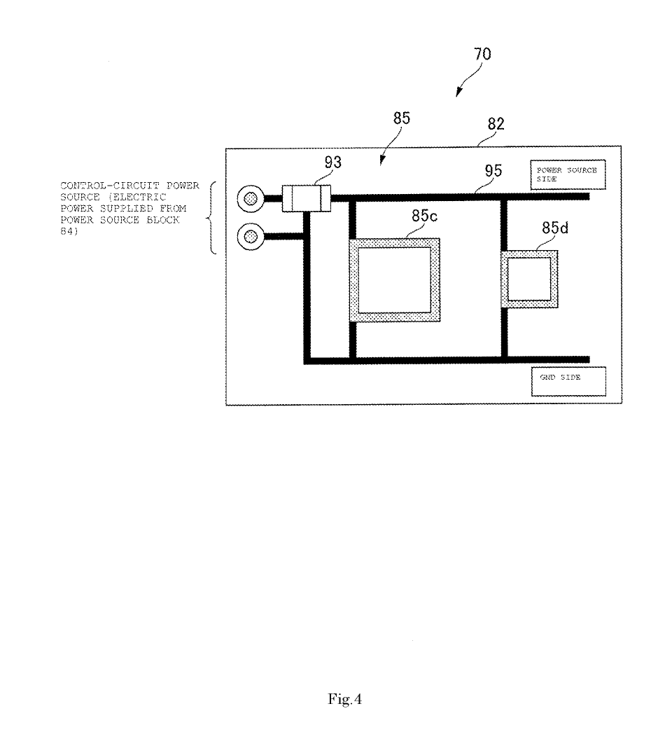

FIG. 4 is a plan view of a motor-driving section 70 according to the present embodiment.

In the motor-driving section 70 according to the present embodiment, a noise filter 93 is disposed in a part of a circuit 95 that is connected to low-heat-generating elements 85c and 85d, which are mounted on the circuit board 82, the part being on the power supply side.

In the present embodiment, the noise filter 93 is disposed between the control block 85 and other blocks. Therefore, in the control block 85, malfunctioning due to noise and deterioration of signal quality due to signal interference or the like with the other blocks can be reduced.

Next, a motor-driving section according to an embodiment of the present invention will be described. In the motor-driving section 70 according to the embodiments described above, the power source block 84 and the drive block 83 share the circuit board 81. However, in the present embodiment, the circuit board 81 is not used in the power source block 84.

FIG. 5 is an enlarged sectional view of a motor-driving section 70 according to the present embodiment.

In the motor-driving section 70 according to the present embodiment, the intermediate-heat-generating element 84a, including an inductor and a capacitor, is separated from the circuit board 81 and disposed in the housing body 71a of the inverter housing 71 via a heat-dissipating member 86. The intermediate-heat-generating element 84a is connected to the circuit board 81 through wiring 89.

In the present embodiment, the intermediate-heat-generating element 84a, including an inductor and a capacitor, is not mounted on a circuit board and is in contact with the housing body 71a of the inverter housing 71 via only the heat-dissipating member 86. Therefore, the influence of heat generated by the high-heat-generating elements 83a and 83b can be reduced, and heat can be efficiently dissipated from the inverter housing 71.

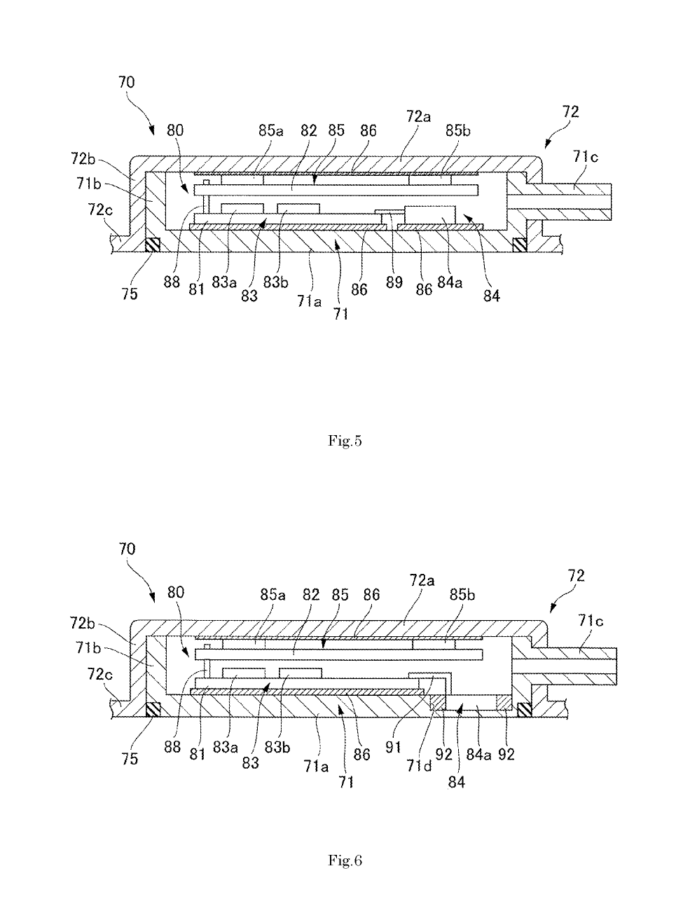

In some of the embodiments described above, the intermediate-heat-generating element 84a is separated from the circuit board 81 and is disposed on the housing body 71a via the heat-dissipating member 86. However, as illustrated in FIG. 6, a recess 71d may be formed in a part of the housing body 71a, and the intermediate-heat-generating element 84a may be disposed in the recess 71d via a heat-dissipating member 92 and may be connected to the circuit board 81 through wiring 91.

Because the intermediate-heat-generating element 84a is disposed in the recess 71d, the area of the housing body 71a facing the intermediate-heat-generating element 84a is increased, and heat dissipation efficiency is increased. Moreover, the height of the intermediate-heat-generating element 84a in the axial direction can be reduced by the depth of the recess 71d, and the size of the entirety of the motor-driving section 70 can be reduced. It may be possible to dispose the intermediate-heat-generating element 84a directly in the recess 71d. However, preferably, the intermediate-heat-generating element 84a is disposed in the recess 71d via the heat-dissipating member 92, because, by dosing so, the intermediate-heat-generating element 84a can more closely contact the housing body 71a and the heat dissipation efficiency is increased.

As the heat-dissipating member 92, for example, a thermosetting resin having a high thermal conductivity, such as silicone rubber; a heat dissipation sheet; a heat dissipation gel; or the like can be used. When using a thermosetting resin, for example, after applying an appropriate amount of the heat-dissipating member 92 to the inside of the recess 71d, the intermediate-heat-generating element 84a is fixed to the housing body 71a, is placed in the recess 71d, and is pressed against the heat-dissipating member 92. By curing the heat-dissipating member 92 in this state, the recess 71d can be easily filled with the heat-dissipating member 92. Moreover, by forming protrusions and recesses on the surface of the housing body 71a, the area of the surface can be increased and the heat dissipation efficiency can be further increased.

Next, a motor-driving section according to an embodiment of the present invention will be described. In the motor-driving section 70 according to the embodiments described above, two circuit boards 81 and 82 are used, and the power source block 84 and the drive block 83 share the circuit board 81. However, in the present embodiment, only one circuit board 81 is used, and the circuit board 81 is not used in the power source block 84.

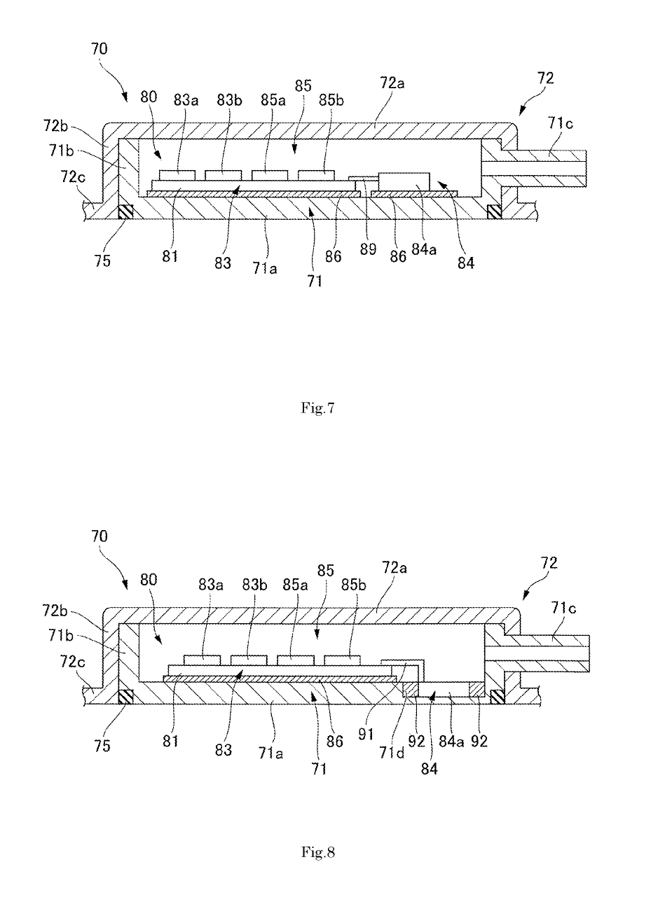

FIG. 7 is an enlarged sectional view of a motor-driving section 70 according to the present embodiment.

In the motor-driving section 70 according to the present embodiment, the high-heat-generating elements 83a and 83b of the block 83 and the low-heat-generating elements 85a and 85b of the block 85 share the circuit board 81. The circuit board 81 is disposed on the housing body 71a of the inverter housing 71 via a heat-dissipating member 86, which contributes to heat transfer. The intermediate-heat-generating element 84a, including an inductor and a capacitor, is separated from the circuit board 81 and disposed on the housing body 71a of the inverter housing 71 via a heat-dissipating member 86. The intermediate-heat-generating element 84a is connected to the circuit board 81 through wiring 89.

In the present embodiment, the intermediate-heat-generating element 84a, including an inductor and a capacitor, is not mounted on a circuit board and is in contact with the housing body 71a of the inverter housing 71 only via the heat-dissipating member 86. Therefore, the influence of heat generated by the high-heat-generating elements 83a and 83b can be reduced, and heat can be efficiently dissipated from the inverter housing 71.

The intermediate-heat-generating element 84a, including an inductor and a capacitor, may be disposed directly on the housing body 71a.

In some of the embodiments described above, the intermediate-heat-generating element 84a is separated from the circuit board 81 and is disposed on the housing body 71a via the heat-dissipating member 86. However, as illustrated in FIG. 8, a recess 71d may be formed in a part of the housing body 71a, and the intermediate-heat-generating element 84a may be disposed in the recess 71d via a heat-dissipating member 92 and may be connected to the circuit board 81 through wiring 91.

Because the intermediate-heat-generating element 84a is disposed in the recess 71d, the area of the housing body 71a facing the intermediate-heat-generating element 84a is increased, and heat dissipation efficiency is increased. Moreover, the height of the intermediate-heat-generating element 84a in the axial direction is reduced by the depth of the recess 71d, and the size of the entirety of the motor-driving section 70 can be reduced. It may be possible to dispose the intermediate-heat-generating element 84a directly in the recess 71d. However, preferably, the intermediate-heat-generating element 84a is disposed in the recess 71d via the heat-dissipating member 92, because, by dosing so, the intermediate-heat-generating element 84a can more closely contact the housing body 71a and the heat dissipation efficiency is increased.

Next, a motor-driving section according to an embodiment of the present invention will be described. In the motor-driving section 70 according to the embodiments described above, the block 83 and the block 84 share the circuit board 81. However, in the present embodiment, different circuit boards are used in the block 83 and the block 84.

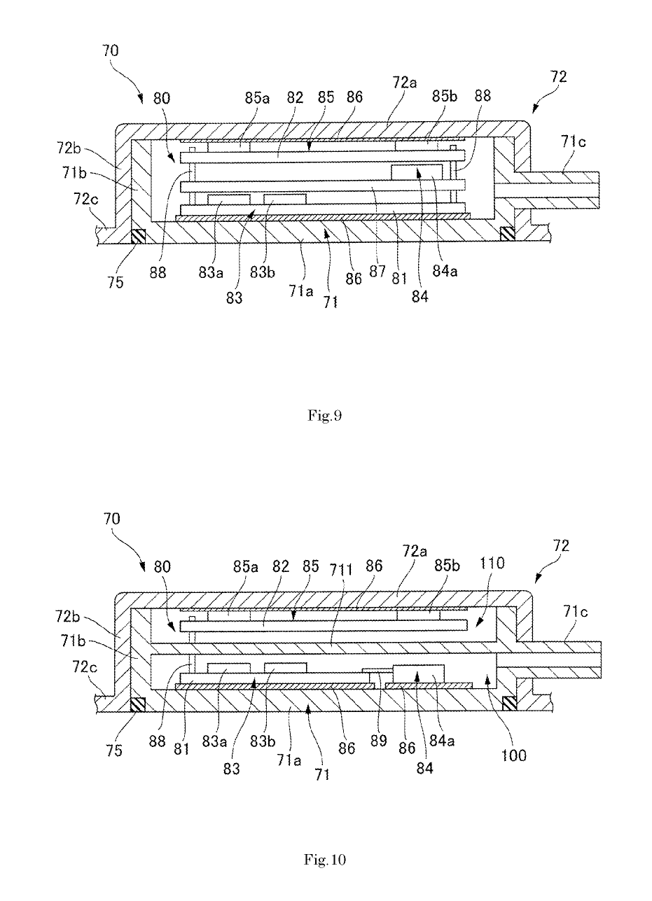

FIG. 9 is an enlarged sectional view of a motor-driving section according to the present embodiment.

In the motor-driving section 70 according to the present embodiment, the intermediate-heat-generating element 84a is mounted on a circuit board 87, which is disposed on the front side (+Z-side) of the circuit board 81 and on the rear side (−Z-side) of the circuit board 82. The intermediate-heat-generating element 84a and the circuit board 87 form the power source block 84. That is, the inverter circuit 80 according to the present embodiment includes the drive block 83, in which the high-heat-generating elements 83a and 83b are mounted on the circuit board 81; the power source block 84, which is on the front side (+Z-side) of the drive block 83 and in which the intermediate-heat-generating element 84a is mounted on the circuit board 87; and the control block 85, which is on the front side (+Z-side) of the power source block 84 and in which the low-heat-generating elements 85a and 85b are mounted on the circuit board 82. The circuit boards in the blocks are connected to each other via wiring 88.

In the present embodiment, the drive block 83, the power source block 84, and the control block 85 have different boards that are separated from each other. Therefore, the influence of noise, which is generated by the drive block 83, on the operation of the control block 85 can be reduced. Moreover, deterioration of signal quality due to interference between the blocks can be suppressed. Furthermore, direct transfer of heat generated by the drive block 83 and the power source block 84 to the control block 85 can be suppressed, and influence due to heat can be reduced.

Next, a motor-driving section according to an embodiment of the present invention will be described. In the embodiments described above, the inverter circuit 80 is disposed in a containing portion formed by the inverter housing 71 and the inverter cover 72. However, in the present embodiment, the inverter circuit 80 is divided into two and disposed in two containing portions.

FIG. 10 is an enlarged sectional view of a motor-driving section 70 according to the present embodiment.

In the motor-driving section 70 according to the present embodiment, a shield portion 711 is disposed on the front side (+Z-side) of the housing body 71a and extends in the radial direction from a central part, in the axial direction, of one of the side walls 71b to the other side wall 71b. That is, in the motor-driving section 70 according to the present embodiment, two containing portions 100 and 110 are formed when the inverter cover 72 is attached to the inverter housing 71.

In the containing portion 100, the block 83 and the block 84 illustrated in FIG. 5 are disposed. In the containing portion 110, the block 85 illustrated in FIG. 5 is disposed. A through-hole (not shown) is formed in the shield portion 711, the wiring 88 is inserted into and extends through the through-hole, and the circuit board 81 and the circuit board 82 are connected.

In the present embodiment, the control block 85 is disposed in a containing portion that is different from and separated from a containing portion that contains the drive block 83 and the power source block 84. Therefore, the influence of noise generated by the drive block 83 on the operation of the control block 85 can be reduced. Moreover, deterioration of signal quality that may occur due to the influence of, for example, interference between the drive block 83 and the control block 85 and interference between the power source block 84 and the control block 85 can be suppressed. Furthermore, direct transfer of heat generated by the drive block 83 and the power source block 84 to the control block 85 can be suppressed, and the influence of heat can be more reliably reduced.

In the present embodiment, two containing portions 100 and 110 are provided. Alternatively, three containing portions may be provided, and each of the drive block 83, the power source block 84, and the control block 85 may be disposed in a corresponding one of the containing portions. Further alternatively, four or more containing portions may be provided. In this case, a functional block may be divided into a plurality of sub-blocks in the same number as the containing portions, and each of the sub-blocks may be disposed in a corresponding one of the containing portions.

The shield portion 711 may be made of a material that is the same as or different from the material of the housing body 71a and the side wall 71b. As a different material, a material having a noise absorbing function, such as a noise absorbing sheet, can be used.

Next, a motor-driving section according to an embodiment of the present invention will be described. In the embodiments described above, the inverter housing 71 is disposed on the front side (+Z-side) of the pump cover 32, and the circuit board 81 is disposed on the front side (+Z-side) of the inverter housing 71. However, in the present embodiment, the pump cover 32 also serves as the inverter housing 71.

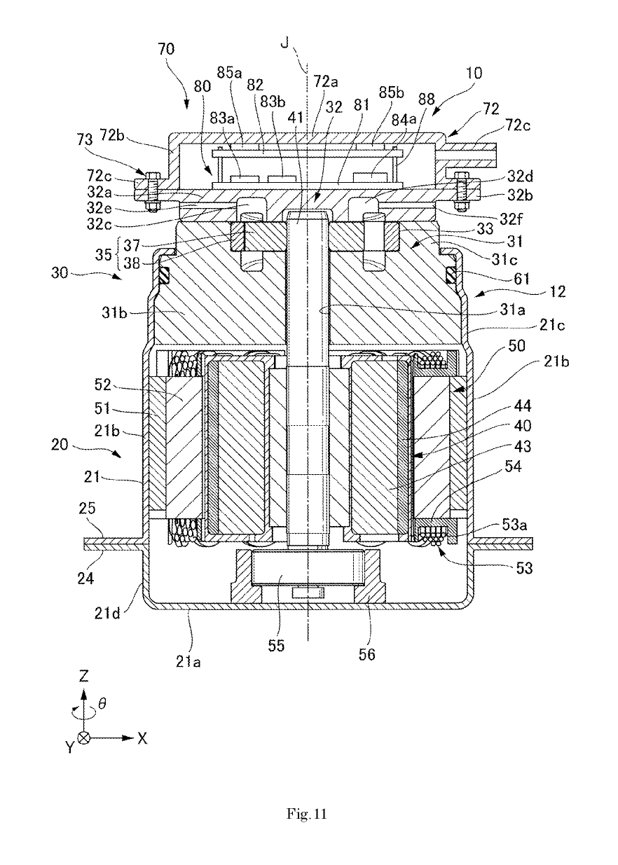

FIG. 11 is a sectional view of an electric oil pump 10 according to the present embodiment.

In the electric oil pump 10 according to the present embodiment, the circuit board 81 is electrically insulated and is directly disposed on the front side (+Z-side) of the pump cover 32, and an inverter circuit 80, which is the same as that of the embodiments described above, is disposed.

In the present embodiment, because the pump cover 32 also serves as the inverter housing 71, the component cost can be reduced, and the efficiency of cooling the circuit board 81 by using a heat sink can be also increased.

The circuit board 81 may be disposed on the front side (+Z-side) of the pump cover 32 via the heat-dissipating member 86.

Heretofore, some embodiments of the present invention have been described. These embodiments are described as examples and are not intended to limit the scope of the invention. These embodiments can be modified in various ways; and various omissions, replacements, and modifications may be performed within the spirit of the invention. Such embodiments and modifications are included in the scope and spirit of the invention and in the equivalents of the invention described in the claims.

For example, some of the embodiments of the present invention may be used in combination. That is, it is possible to apply the pump cover 32 according one of the embodiments that also serves as an inverter housing may be used for the inverter circuit 80 according to any of the other embodiments.

In the embodiments described above, the high-heat-generating elements 83a and 83b are disposed in the drive block 83, the intermediate-heat-generating element 84a is disposed in the power source block 84, and the low-heat-generating elements 85a and 85b are disposed in the control block 85. However, some of the blocks may include some heat-generating elements in another group.

Moreover, in the embodiments described above, the discharge opening 32f is formed in the pump cover 32 (see FIG. 1). However, instead of in the pump cover 32, the discharge opening 32f may be formed in the bottom-surface portion 21a or the side-wall portion 21d of the housing 21. In this case, the gap between the shaft 41 and the pump body 31 in the axial direction serves as an outlet hole for feeding oil from the pump section 30 to the motor section 20.

With such a modification, in the through-hole 31a, oil flowing from the pump section 30 can be used as lubricating oil, and the through-hole 31a functions as a plane bearing that rotatably supports the shaft 41. Moreover, oil can be efficiently fed to the motor section 20 without forming an independent outlet hole.

A cutout portion may be formed in at least one of the outer peripheral surface of the shaft 41 and the inner peripheral surface of the pump body 31. In this case, flow resistance when oil flows through the gap between the shaft 41 the pump body 31 is reduced, and oil can be more efficiently fed from the pump section 30 to the motor section 20.

The pump body 31 may further include a bearing in addition to the plane bearing structure described above. In this case, oil may pass through the inside of the bearing or may flow through the gap between the shaft 41 and the bearing.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a motor section that includes a shaft that is rotatably supported around a central axis extending in an axial direction; and
a motor-driving section that is positioned on one side of the motor section in the axial direction and that drives the motor section,
wherein the motor section includes
a rotor that is rotatable around the shaft,
a stator that is disposed outside of the rotor in a radial direction, and
a housing that contains the rotor and the stator, wherein the motor-driving section includes
an inverter circuit that includes a circuit board and a plurality of heat-generating elements mounted on the circuit board and that controls driving of the motor section, and
an inverter case that contains the inverter circuit, and
wherein the inverter circuit includes a plurality of blocks including a power source block, a drive block, and a control block, and at least one of the plurality of blocks is separated from the other blocks.

2. The motor according to claim 1,
wherein a circuit board of the control block and a circuit board of the drive block differ from each other.

3. The motor according to claim 1,
wherein a circuit board of the control block and a circuit board of the power source block differ from each other.

4. The motor according to claim 1,
wherein a circuit board of the control block, a circuit board of the drive block, and a circuit board of the power source block differ from one another.

5. The motor according to claim 1,
wherein at least one of the drive block, the power source block, and the control block thermally contacts the inverter case via a heat-dissipating member.

6. The motor according to claim 1,
wherein the power source block is separated from the drive block and the control block, and the heat-generating element of the power source block is thermally in contact with the inverter case.

7. The motor according to claim 6,
wherein the drive block and the control block share one circuit board.

8. The motor according to claim 7,
wherein a recess is formed in the inverter case, and the heat-generating element of the power source block is contained in the recess.

9. The motor according to claim 8,
wherein the heat-generating element of the power source block is contained in the recess via a heat-dissipating member.

10. The motor according to claim 1,
wherein the control block and the drive block are disposed in different containing portions.

11. The motor according to claim 1,
wherein the control block and the power source block are disposed in different containing portions.

12. The motor according to claim 1,
wherein the control block, the drive block, and the power source block are disposed in different containing portions.

13. The motor according to claim 1,
wherein the inverter case includes
an inverter housing that contains the inverter circuit, the inverter housing including a side wall, a recess including a bottom surface that is positioned on the other side of the motor section in the axial direction, and an opening on the one side of the motor section in the axial direction, and
an inverter cover that covers the opening, and
wherein the drive block and the power source block are disposed on the inverter housing.

14. The motor according to claim 13,
wherein the drive block and the power source block thermally contact the inverter housing via a heat-dissipating member.

15. The motor according to claim 13,
wherein the control block is disposed on the inverter cover.

16. The motor according to claim 15,
wherein the circuit board is a copper inlay board.

17. The motor according to claim 16,
wherein the drive block includes a field-effect transistor, and the power source block includes a capacitor.

18. The motor according to claim 17,
wherein a noise filter is disposed between the control block and another of the blocks.

19. An electric oil pump comprising:
a motor section including a shaft that is rotatably supported around a central axis extending in an axial direction;
a pump section that is positioned on one side of the motor section in the axial direction, that is driven by the shaft extending from the motor section, and that discharges oil; and
a motor-driving section that is positioned, via the pump section, on one side of the motor section in the axial direction and that drives the motor section,
wherein the motor section includes
a rotor that is rotatable around the shaft,
a stator that is disposed outside of the rotor in a radial direction, and
a housing that contains the rotor and the stator,
wherein the pump section includes
a pump rotor attached to the shaft,
a pump body that contains the pump rotor, the pump body including a side wall, a recess including a bottom surface that is positioned on the other side of the motor section in the axial direction, and an opening on the one side of the motor section in the axial direction, and
a pump cover that covers the opening,
wherein the motor-driving section includes
an inverter circuit that controls driving of the motor section, and
an inverter case that contains the inverter circuit,
wherein the inverter circuit includes a block including a high-heat-generating element, a block including an intermediate-heat-generating element that generates a smaller amount of heat than the high-heat-generating element, and a block including a low-heat-generating element that generates a smaller amount of heat than the intermediate-heat-generating element, and
wherein the block including the high-heat-generating element and the block including the intermediate-heat-generating element thermally contact the inverter case.

20. The electric pump according to claim 19,
wherein a suction opening for suctioning oil is formed at a position in the pump cover, an oil discharge opening for discharging the oil is formed in the pump cover on a side opposite to the position of the suction opening with respect to the central axis, and the block including the high-heat-generating element is disposed on a side closer than the central axis to the suction opening.
